(19) United States
(12) Patent Application Publication
(10) Pub. No.: US 2008/0165959 A1
(43) Pub. Date: Jul. 10, 2008

(54) Encrypted data players and encrypted data player systems

(75) Inventors: Jae-In Hong, Kwangmyeong-si (KR); Joon-Seok Kim, Seoul (KR); Jae-Hong Park, Seongnam-si (KR); Young-Jun Kwon, Seongnam-si (KR); Tae-Sun Kim, Yongin-si (KR)

Correspondence Address: HARNESS, DICKEY & PIERCE, P.L.C., P.O. BOX 8910, RESTON, VA, 20195, US

(73) Assignee: Samsung Electronics Co. Ltd.

(21) Appl. No.: 11/701,448

(22) Filed: Feb. 2, 2007

(30) Foreign Application Priority Data
Feb. 16, 2006 (KR) 10-2006-0015202

(51) Int. Cl. H04N 7/167; H04L 9/08

(52) U.S. Cl. 380/200; 380/278

(57) ABSTRACT

An encrypted data player device is configured to process encrypted key and encrypted data received through a system bus. The encrypted data player device includes a device key storage circuit and a decryption circuit. The device key storage circuit is configured to store a device key. The decryption circuit is configured to receive the device key directly from the device key storage circuit, decode the encrypted key using the device key and decode the encrypted data using the decrypted key.

### PRIORITY STATEMENT

This non-provisional U.S. patent application claims priority under 35 U.S.C. § 119 to Korean Patent Application No. 10-2006-0015202, filed on Feb. 16, 2006, in the Korean Intellectual Property Office (KIPO) the entire contents of which are incorporated herein by reference.

### BACKGROUND

A digital video disk (DVD) is the same or substantially the same size as a conventional compact disk (CD), but may record a movie in a TV-broadcasting quality. Conventionally, the recording capacity of a DVD is six to eight times of conventional CDs. Image data stored in the DVD may be compressed in, for example, moving picture experts group (MPEG)-2 international standard. The DVD may be used as an image storage medium capable of storing higher-quality movies, and may also be used as a DVD-ROM instead of next generation CD-ROMs. Accordingly, the DVD is increasingly used in fields of PC games or game consoles.

The DVD is a storage medium in which a large amount of information is stored in a digital format. Once stored, the data may not deteriorate and may be used semi-permanently. DVDs are applicable to many fields, and thus, are becoming increasingly popular. In addition, DVD players playing image or sound data of movies or music are becoming increasingly popular. Moreover, the business of selling or renting movie or music DVDs has increased steadily and secures a relatively large market.

However, because the contents of the DVD may be duplicated relatively easily, numerous illegal DVDs are in circulation. Accordingly, in a DVD-related business, suppressing or preventing illegal DVD copies and usage of the digital contents stored in the DVD is relatively important. To do so, data stored in a DVD may be encrypted using a standardized encryption algorithm. Encrypted data may not be played unless the encrypted data is decrypted using an appropriate key.

To suppress and/or prevent illegal playing and/or recording of DVDs, a content protection system (CPS) in a conventional DVD system uses key processing to calculate an appropriate key for decrypting the encrypted data and performs an authorizing process for a player and a user. Thus, the CPS suppresses and/or prevents the data from being illegally copied, and also more effectively controls content access.

FIG. 1 is a block diagram of a conventional DVD system. Referring to FIG. 1, the DVD system 100 includes a DVD 110, a DVD player 120 and a display device 130. The DVD 110 may include an encrypted media key (EMK) 111, an encrypted title key (ETK) 112 and an encrypted data (ED) 113. The encrypted data (ED) 113 may be encrypted using a content scrambling system (CSS). The CSS is not a public encryption system, but instead a DVD copy control association (CCA) controls the CSS and a license for data manufacturer. In most instances, the manufacturer of the DVD system may pay a fee for DVD-CCA license to obtain or acquire a CSS key for playing DVD, and may also protect the DVD data by only playing and copying images in an allowable range of the DVD license.

The DVD player 120 may include a system bus 121, a memory 122, a key decryption and control unit 123, a decryption circuit 124, a video signal controller 127 and an interface 128. The decryption circuit 124 may include a device key storage circuit 125 and a data decryption circuit 126. The system bus 121 may exchange control signals and data between devices in the DVD player 120 to process data read from the DVD 110. The memory 122 may be volatile memory used in the signal process of the DVD player 120.

The device key storage circuit 125 may include a device key (DK) for decrypting a media key recorded on the DVD 110. The device key storage circuit 125 may send the device key (DK) into the key decryption and control unit 123 through the system bus 121 to decrypt the encrypted media key (EMK) 111 read from the DVD 110.

The key decryption and control unit 123 may read the encrypted media key (EMK) 111 stored on the DVD 110 and the device key (DK) stored in the device key storage circuit 125, and decrypt the encrypted media key (EMK) 111 using the device key (DK). The encrypted media key (EMK) 111 may be encrypted using software. The key decryption and control unit 123 may read the encrypted title key (ETK) 112 of the DVD 110, and decrypt the encrypted media key (EMK) 111 using a decrypted title key (DMK). The key decryption and control unit 123 may transmit (or alternatively send or deliver) a decrypted title key (DTK) to the data decryption circuit 126 through the system bus 121.

The data decryption circuit 126 may decrypt the encrypted data read from the DVD 110 using the decrypted title key (DTK). The data decryption circuit 126 may transmit the decrypted data (DD) to the video signal controller 127 directly or indirectly through the system bus 121. The video signal controller 127 may perform a video signal process on the decrypted data (DD) (e.g., MPEG decoding) to transmit the video-signal-processed data into a display device 130 through the interface 128.

Still referring to the DVD system 100 of FIG. 1, the key decryption and control unit 123 may receive the device key (DK) stored in the device key storage circuit 125 through the system bus 121, and store the device key (DK) in a register.

The above-discussed operations may be monitored and/or accessed externally using a debugging method. For example, a register (e.g., in the key decryption and control unit 123 or the device key storage circuit 125) storing the device key (DK) may be accessed externally through the system bus 121. Because the device key (DK) is externally exposed to the outside, the encrypted data may be more easily hacked or illegally accessed.

### SUMMARY

Example embodiments relate to encrypted data player systems, for example, to encrypted data players capable of decrypting encrypted data using encrypted key and encrypted data player systems including the same. Moreover, at least some example embodiments provide encrypted data players for suppressing or preventing encrypted key from being accessed when encrypted data is played and encrypted data player systems including the same.

At least one example embodiment provides an encrypted data player device for processing an encrypted key and an encrypted data received through a system bus. The device may include a device key storage circuit and a decryption circuit. The device key storage circuit may be configured to store a device key. The decryption circuit may be configured to receive the device key directly from the device key storage circuit, decrypt the encrypted key using the device key and decrypt the encrypted data using the decrypted key.

In at least some example embodiments, the encrypted key and the encrypted data may be received from the same storage medium. The device key storage circuit may not be externally accessible through the system bus. The encrypted data player device may be a DVD player. The encrypted key received from the system bus may be an encrypted media key and an encrypted title key. The decryption circuit may decrypt the encrypted media key using the device key stored in the device key storage circuit, and may decrypt the encrypted title key using the decrypted media key. The decryption circuit may further include a register configured to store the decrypted media key, for example, temporarily.

At least one other example embodiment provides an encrypted data player system. According to at least this example embodiment, an encrypted data player system may include a storage medium and an encrypted data player device. The storage medium may be configured to store an encrypted key and encrypted data. The encrypted data player device may be configured to decrypt the encrypted key and encrypted data stored in the storage medium. The encrypted data player device may be further configured to perform a video-signal processing on the decrypted data, and a display system configured to output the video-signal processed data, wherein the encrypted data player device includes a device key storage circuit configured to store a device key. The encrypted data player system may further include a decryption circuit configured to receive the device key directly from the device key storage circuit, decrypt the encrypted key using the device key and decrypt the encrypted data using the decrypted key.

In at least some example embodiments, the storage medium may be a DVD and the encrypted data player device may be a DVD player. The device key storage circuit may not be externally accessible through the system bus. The encrypted key received through the system bus may be an encrypted media key and an encrypted title key. The decryption circuit may decrypt the encrypted media key using a device key stored in the device key storage circuit, and may decrypt the encrypted title key using the decrypted media key. The decryption circuit may further include a register for storing the decrypted media key temporarily.

In at least one example embodiment, an encrypted data player device may decrypt encrypted data received from a system bus using a device key, the device key may be stored in a memory not directly accessible through the system bus.

In at least some example embodiments, the encrypted data player device may include a system bus, a device key storage circuit configured to store a device key and a decryption circuit. The decryption circuit may include a data interface, a decryption controller and a decryption engine. The data interface may be configured to receive encrypted data via the system bus. The decryption controller may be configured to output a first and a second selection signal to a first and a second selection circuit, respectively. The first selection circuit may be configured to select one of an encrypted media key, an encrypted title key and encrypted data in response to the first selection signal, and the second selection circuit may be configured to select one of the device key and an intermediate key in response to the second selection signal. The device key may be received directly from the device key storage device without traversing the system bus. The decryption engine may be configured to decrypt the selected one of the encrypted media key, an encrypted title key and encrypted data using the selected one of the device key and an intermediate key.

### BRIEF DESCRIPTION OF THE FIGURES

The accompanying figures are included to provide a further understanding of the example embodiments, and are incorporated in and constitute a part of this specification. The drawings illustrate example embodiments and together with the description serve to explain the present invention. In the figures:

FIG. 1 is a block diagram of a conventional encrypted data player system;

FIG. 2 is a block diagram of an encrypted data player system according to an example embodiment; and

FIG. 3 is a block diagram of a key and a data decryption circuit according to an example embodiment.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

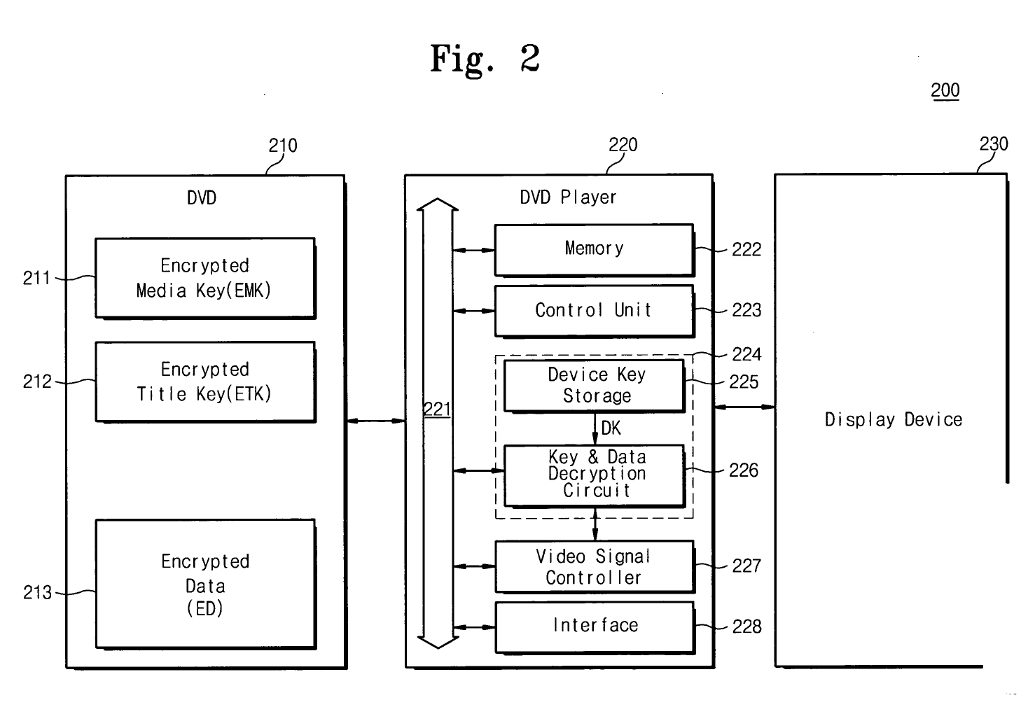

FIG. 2 is a block diagram of an encrypted data player system according to an example embodiment. In FIG. 2, a digital video disk (DVD) system is shown as one example of an encrypted data player system. However, encrypted data player systems according to example embodiments may include any and all audio or image system that play encrypted data and output the played data as an audio or image. In other words, example embodiments may be applicable and/or be implemented in conjunction with any data player system. For the sake of clarity, FIG. 2 will be described with regard to a DVD player and a DVD system.

Referring to FIG. 2, DVD system 200 may include a DVD player 220 and/or a display device 230. The DVD player 220 may include a decryption circuit 224. The decryption circuit 224 may further include a device storage key 225 and a key and data decryption circuit 226. The key and data decryption circuit 226 may decrypt a key and/or data. Because encrypted data player systems, according to example embodiments, may decrypt the key and data without passing through a system bus 221, data player systems according to example embodiments may be safer from system intrusion (e.g., hacking and/or illegal access).

The DVD system 200 of FIG. 2 may play (e.g., read, write or access) encrypted DVD. DVD 210 may include an encrypted media key (EMK) 211, an encrypted title key (ETK) 212 and/or an encrypted data (ED) 213. The encrypted media key (EMK) 211 may be an encrypted key for the DVD itself. The encrypted title key (ETK) 212 may be an encrypted key assigned to data recorded on the DVD. The encrypted data (ED) 213 may include corresponding title keys, and each title key may be the same as or different from each other.

In addition to the decryption circuit 224, the DVD player 220 may include a system bus 221, a memory 222, a control unit 223, a video signal controller 227 and/or an interface 228. The system bus 221 may deliver the key or data read from the DVD 210 to one or more devices or components (e.g., each device or component) in the DVD player 220. The system bus 221 may also deliver a control signal and/or data between respective devices or components.

The memory 222 may be used as a working memory when the DVD player 220 processes a signal. The memory 222 may be, for example, a DRAM, SRAM, or the like, which are randomly accessible.

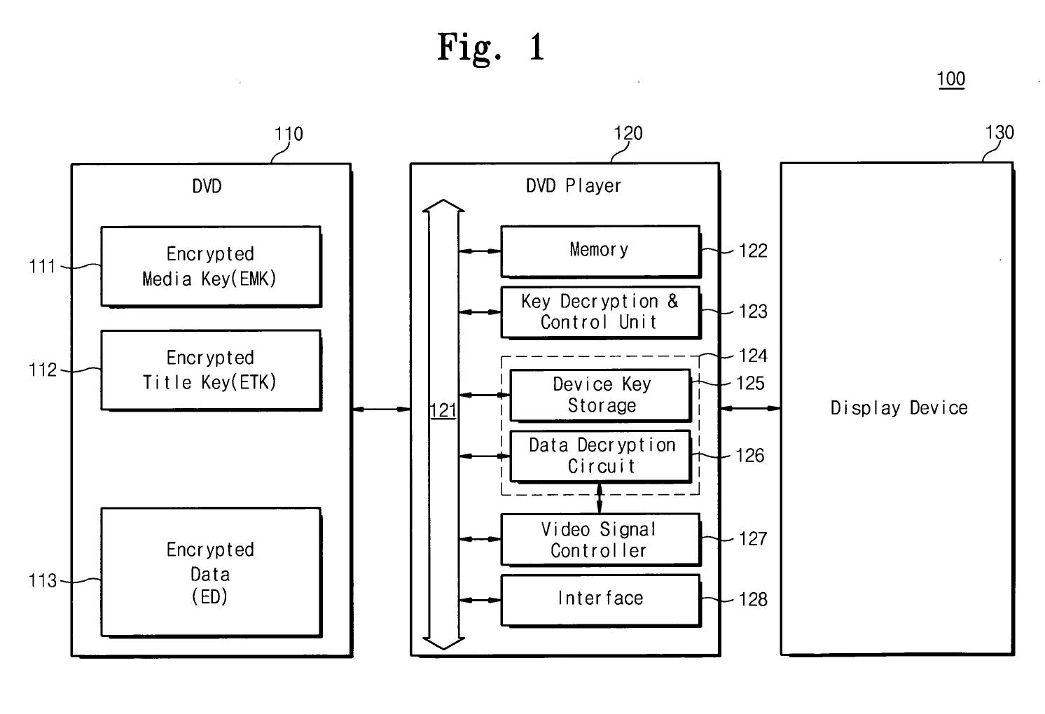

The control unit 223 may control operations of the DVD player 220. In FIG. 1, for example, the conventional key decryption and control unit 123 may receive a device key (DK) and perform a key decryption operation via the system bus 121. On the other hand, the control unit 223 of FIG. 2 may not take part in the key decryption process. The key decryption process may be performed in the decryption circuit 224 described in more detail below.

As discussed above, the decryption circuit 224 may include a device key storage circuit 225 and/or a key and data decryption circuit 226. The decryption circuit 224 may decrypt the encrypted media key (EMK) 211, the encrypted title key (ETK) 212 and/or the encrypted data (ED) 213 stored in the DVD 210 using the device key (DK). The decryption circuit 224 may perform a decryption operation through the key and data decryption circuit 226, which may be implemented using hardware, without passing the system bus 221.

The device key storage circuit 225 may store a device key (DK) for decrypting the encrypted media key (EMK) 211 stored in the DVD 210. The device key storage circuit 225 may provide the device key (DK) into the key and data decryption circuit 226 by the control unit 223 during a decryption operation. The device key storage circuit 225 may be embodied using various storage devices such as a memory, a register, etc. For example, the device key storage circuit 225 may be a non-volatile memory such as a flash memory or the like.

The key and data decryption circuit 226 may perform (e.g., sequentially perform) a key decryption operation and/or a data decryption operation. The key and data decryption circuit 226 may read the encrypted media key (EMK) 211 stored in the DVD 210 and the device key (DK) stored in the device key storage circuit 225, and decrypt the encrypted media key (EMK) 211 using the device key (DK). The key and data decryption circuit 226 may decrypt the encrypted title key (ETK) 212 stored in the DVD 210 using the decrypted media key.

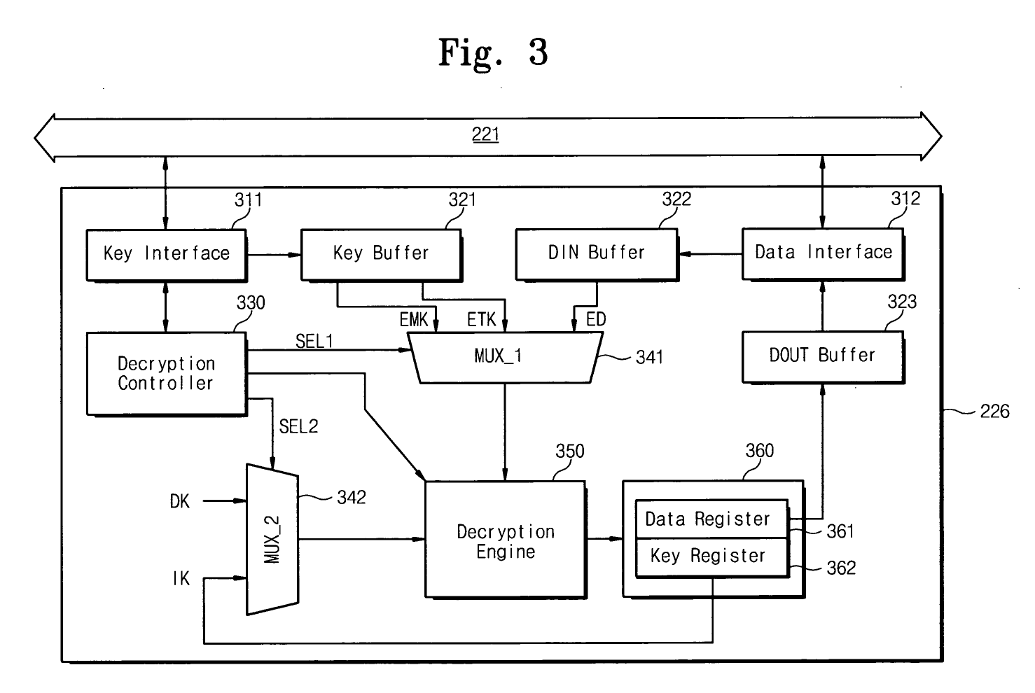

The key and data decryption circuit 226 may decrypt the encrypted data (ED) stored in the DVD 210 using the decrypted title key (DTK). The key and data decryption circuit 226 may deliver a decrypted data (DD) to the video signal controller 227 directly or indirectly through the system bus 221. The internal configuration and operational principle of a key and data decryption circuit, according to an example embodiment, such as key and data decryption circuit 226 of FIG. 2 will be described in more detail with regard to FIG. 3.

The video signal controller 227 may perform a video signal process (e.g., an MPEG decrypting) using decrypted data (DD) provided from the decryption circuit 224. The interface 228 may provide the video signal processed image signal into a display device 230.

FIG. 3 is a block diagram of a key and a data decryption circuit according to an example embodiment. Referring to FIG. 3, key and data decryption circuit 226 may include a plurality of interfaces 311 and 312, a plurality of buffer circuits 321, 322, and 323, a decryption controller 330, a plurality of selection circuits 341 and 342, a decryption engine 350 and/or a register 360.

The plurality of interfaces 311 and 312 may include a key interface 311 and/or a data interface 312. The key interface 311 may receive an encrypted media key (EMK) and/or an encrypted title key (ETK) via the system bus 221. The key interface 311 may provide or send a command to the decryption controller 330. The key interface 311 may send the encrypted media key (EMK) and/or the encrypted title key (ETK) to the key buffer 321.

The data interface 312 may exchange data through the system bus 221. The data interface 312 may receive the encrypted data (ED) and send the encrypted data (ED) to the data input buffer 322 through the system bus 221. Alternatively, the data interface 312 may receive the decrypted data (DD) from the data output buffer 323, and send the decrypted data (DD) to the system bus 221.

The plurality of buffer circuits 321, 322 and 323 may include a key buffer 321, a data input buffer 322 and/or a data output buffer 323. The key buffer 321 may send an encrypted media key (EMK) and/or an encrypted title key (ETK) received through the key interface 311 to a first multiplexer 341. The data input buffer 322 may receive an encrypted data (ED) via the data interface 312 and output the encrypted data (ED) to the first multiplexer 341. The data output buffer 323 may deliver the decrypted data into the data interface 312.

The decryption controller 330 may control operations of the key and data decryption circuit 226 according to commands through the key interface 311. The decryption controller 330 may provide first and second selection signals SEL1 and SEL2 to first and second multiplexers, respectively, during a key or data decryption operation. The decryption controller 330 and may control the decryption engine 350 to perform an actual key or data decryption operation.

The plurality of selection circuits 341 and 342 may include first and second multiplexers 341 and 342. The first multiplexer 341 may select one of an encrypted media key (EMK), an encrypted title key (ETK) and encrypted data (ED) in response to a first selection signal SEL1 provided from the decryption controller 330, and send the selected key or data to the decryption engine 350. The second multiplexer 342 may select one of a device key (DK) and an intermediate key (IK) in response to a second selection signal SEL2 provided from the decryption controller 330, and deliver the selected key or data to the decryption engine 350. In this example, the intermediate key (IK) may be one of a decrypted media key (DMK) and a decrypted title key (DTK).

In one example, the decryption engine 350 may receive a device key (DK) stored in the device key storage circuit 225 via the second multiplexer 342, and receive an encrypted media key (EMK) via the first multiplexer 341. The decryption engine 350 may decrypt the encrypted media key (EMK) using the device key (DK) in response to a control signal from the decryption controller 300. The decryption engine 350 may store the decrypted media key (DMK) to the key register 362.

The decryption engine 350 may receive the decrypted media key (DMK) stored in the key register 362 via the second multiplexer 342, and may receive an encrypted title key (ETK) via the first multiplexer 341. The decryption engine 350 may decrypt the encrypted title key (ETK) using the decrypted media key (DMK) in response to a control signal from the decryption controller 300. The decryption engine 350 may store the decrypted title key (DTK) into the key register 362.

The decryption engine 350 may receive an encrypted title key (DTK) stored in the key register 362 via the second multiplexer 342, and may receive the encrypted data (ED) via the first multiplexer 341. The decryption engine 350 may decrypt the encrypted data (ED) using the decrypted title key (DTK) in response to a control signal from the decryption controller 300. The decryption engine 350 may store the decrypted data (DD) into the data register 362.

As noted above, the register 360 may include a data register 361 and/or a key register 362. The data register 361 may store decrypted data (DD) from the decryption engine 350, and may provide the decrypted data (DD) to the data output buffer 323. The key register 362 may provide the decrypted media key (DMK) or a decrypted title key (DTK) to the second multiplexer 342. For example, the key register 362 may provide the decrypted media key (DMK) to the second multiplexer 342 when the decrypted title key (ETK) is decrypted or the decrypted title key (DTK) to the second multiplexer 342 when the encrypted data (ED) is decrypted.

As described above, the decryption circuit 226 may decrypt the encrypted media key (EMK) input through the system bus 221 using the device key (DK). The decryption circuit 226 may decrypt an encrypted title key (ETK) input through the system bus 221 using the decrypted media key (DMK). The decryption circuit 226 may decrypt the encrypted data (ED) input from the system bus 221 using the decrypted title key (DTK).

Referring back to FIG. 2, in the encrypted data player system 200, the encrypted key may not decrypted using software as is the case with the conventional system shown in FIG. 1, but instead may be decrypted using hardware in the decryption circuit 226. In the conventional encrypted data player system 100 of FIG. 1, the encrypted media key (EMK) and the encrypted title key (ETK) 111 are decrypted. However, the encrypted data player system 200 according to at least some example embodiments may decrypt the encrypted media key (EMK) 211 and/or the encrypted title key (ETK) 212 using the device key (DK) in the decryption circuit 226 without passing the system bus 221.

In the encrypted data player system 200 of FIG. 2, because the device key storage circuit 225 storing a device key (DK) may not be externally accessible, and may not pass through the system bus 221, the device key storage 225 is not exposed to the outside. For example, according to at least some example embodiments, because an encrypted key is not exposed during the decrypting operation of the encrypted key, the encrypted data may be restored more safely and/or be more secure.

According to at least one example embodiment, an encrypted key may include a media key and/or a title key. However, example embodiments are not limited to the encrypted key, and may be applied to an encrypted data player system having more, less or various encrypted keys.

In a data processor according to at least some example embodiments, when encrypted data is played, an encrypted key may be less externally accessible or in some cases externally inaccessible. Therefore, the data processor may be more secure and/or safer from external system intrusion.

In at least some example embodiments, recorded data on the DVD or other storage medium may refer to data stored on the DVD or any other suitable storage medium.

The above-disclosed subject matter is to be considered illustrative, and not restrictive, and the appended claims are intended to cover all such modifications, enhancements, and other example embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An encrypted data player device configured to decrypt encrypted data received from a system bus using a device key, the device key being stored in a storage medium, the storage medium not being directly accessible through the system bus.

2. The encrypted data player device of claim 1, further including,
a device key storage circuit as the storage medium, and
a decryption circuit configured to receive the device key directly from the device key storage circuit, decrypt an encrypted key using the device key, and decrypt encrypted data using the decrypted key.

3. The device of claim 2, wherein the encrypted key and the encrypted data are received from the same storage medium.

4. The device of claim 2, wherein the device key storage circuit is not externally accessible through the system bus.

5. The device of claim 2, wherein the encrypted data player device is a digital video disk player.

6. The device of claim 2, wherein the encrypted key received from the system bus is an encrypted media key and an encrypted title key.

7. The device of claim 6, wherein the decryption circuit is configured to decrypt the encrypted media key using the device key stored in the device key storage circuit, and decrypt the encrypted title key using the decrypted media key.

8. The device of claim 7, wherein the decryption circuit further includes,
a register configured to store the decrypted media key.

9. An encrypted data player system comprising:
a storage medium configured to store an encrypted key and an encrypted data,
the encrypted data player device of claim 1, the encrypted data player device being further configured to perform a video-signal processing on the decrypted data, and
a display system configured to output the video-signal processed data.

10. The system of claim 9, wherein the encrypted data player device includes,
a device key storage circuit as the storage medium, and
a decryption circuit configured to receive the device key directly from the device key storage circuit, decrypt an encrypted key using the device key, and decrypt encrypted data using the decrypted key.

11. The system of claim 9, wherein the storage medium is a digital video disk player.

12. The system of claim 9, wherein the device key storage circuit is not externally accessible through the system bus.

13. The system of clam 9, wherein the encrypted data player device is a digital video disk player.

14. The system of claim 9, wherein the encrypted key received through the system bus is an encrypted media key and an encrypted title key.

15. The system of claim 14, wherein the decryption circuit is configured to decrypt the encrypted media key using the device key stored in the device key storage circuit, and decrypt the encrypted title key using the decrypted media key.

16. The system of claim 15, wherein the decryption circuit further includes,
a register configured to temporarily store the decrypted media key.

17. The device of claim 1, further including
a system bus;
a device key storage circuit configured to store a device key; and
a decryption circuit, the decryption circuit including,
a data interface configured to receive encrypted data via the system bus;
a decryption controller configured to output a first and a second selection signal to a first and a second selection circuit, respectively, the first selection circuit being configured to select one of an encrypted media key, an encrypted title key and encrypted data in response to the first selection signal, and the second selection circuit being configured to select one of the device key and an intermediate key in response to the second selection signal, the device key being received directly from the device key storage device without traversing the system bus; and
a decryption engine configured to decrypt the selected one of the encrypted media key, an encrypted title key and encrypted data using the selected one of the device key and an intermediate key.

18. An encrypted data player system comprising:
a storage medium configured to store an encrypted key and an encrypted data,
the encrypted data player device of claim 17, the encrypted data player device being further configured to perform a video-signal processing on the decrypted data, and
a display system configured to output the video-signal processed data.

19. The system of claim 18, wherein the storage medium is a digital video disk player.

20. The system of claim 18, wherein the storage medium storing the device key is not externally accessible through the system bus.
